(19) United States
(12) Patent Application Publication
(10) Pub. No.: US 2016/0070707 A1
(43) Pub. Date: Mar. 10, 2016

(54) KEYWORD SEARCH ON DATABASES

(71) Applicants: Lei WANG, Beijing (CN); Shimin CHEN, Beijing (CN); Yi GONG, Port, Shanghai (CN); Meng GUO, Shanghai (CN); HEWLETT-PACKARD DEVELOPMENT COMPANY, L.P., Houston, TX (US)

(72) Inventors: Lei Wang, Beijing (CN); Shimin CHEN, Beijing (CN); Yi GONG, Shanghai (CN); Meng GUO, Shanghai (CN)

(21) Appl. No.: 14/782,345

(22) PCT Filed: Apr. 5, 2013
(86) PCT No.: PCT/CN2013/073768

§ 371 Date: Oct. 5, 2015

(51) Int. Cl. G06F 17/30

(52) U.S. Cl. CPC G06F 17/3053; G06F 17/30011; G06F 17/30389; G06F 17/30336; G06F 17/30498

(57) ABSTRACT

Systems and methods for keyword based searching in a database are described herein. In one implementation, the method comprises receiving a keyword based query, comprising at least one keyword, from a user. The method further comprises searching an inverted index associated with the database to detect the presence of at least one of the keywords in documents, identified by a document ID, present in the inverted index. Based on the searching, the documents in which at least one of the keywords is present are identified. The identified documents are then ranked in a descending order of relevancy.

### BACKGROUND

Generally databases are extensively used to store information. For example, an organization may have multiple databases to store a variety of information, such as a directory of the employees, mailing list information, product details and sales details. Various applications are developed or are in-built within these databases to seamlessly search, access and browse the data stored in these databases. These applications generally include a user interface which is closely associated with the schema of the databases to facilitate searching in a structured manner. However, to use structured searches effectively, the users should be familiar with the details of the schema of the various databases. Furthermore, building customized applications for searching the databases is time consuming.

Internet search engines have made keyword based searches very popular. In keyword based searches, the user submits keywords to the search engine and is provided with a list of documents in a descending order of relevancy.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a schematically illustrates a keyword based search system, according to an example of the present subject matter.

FIG. 1b schematically illustrates the keyword based search system in a network environment, according to another example of the present subject matter.

FIG. 2a illustrates a method for keyword based searching, according to an example of the present subject matter.

FIG. 2b illustrates a method for keyword based searching, according to another example of the present subject matter.

FIG. 2c illustrates a method for keyword based searching, according to another example of the present subject matter.

FIG. 3 illustrates a computer readable medium storing instructions for keyword based searching, according to an example of the present subject matter.

### DETAILED DESCRIPTION

The present subject matter relates to systems and methods for keyword based searching. The methods and the systems as described herein may be implemented using various commercially available computing systems.

Internet search engines have made keyword based searches very popular. However, the keyword based searches over databases are used very sparingly as the databases have an inherent structure based on which required information may be stored in one or more of a plurality of tables or columns of the databases. Moreover, keyword based searches over databases have large space and time overheads as well as manageability concerns. Further, keyword based searches fail to use the native query processing functionality of the databases. The techniques of keyword based searching on databases provide many technical challenges such as structural ambiguity and keyword ambiguity. Structural ambiguity refers to the mismatch between the schema of a database and an unstructured keyword query.

Keyword based searches are significantly more complex when executed on enterprise databases, as the enterprise databases include a high number of tables and logical views. The logical views can be considered as a join on multiple tables of the same database or different databases. Moreover, the problem of generating the optimal candidate structures in response to a keyword query is a non-deterministic polynomial-time hard (NP-hard) problem. The time complexity of a typical approximation method of the NP hard problem may be O(n² log n), where n is the number of candidate nodes that contain keywords in the query. Further, the candidate structures also have to be arranged based on relevancy. Commercially available techniques involve implementing complex scoring functions to rank sub-structures and candidate nodes within each candidate structure.

Generally, a keyword query may be mapped to multiple structure possibilities or results. For example, if in the database, a tuple is regarded as a node, represented by V, and a primary key-foreign key relationship as an edge, represented by E, then the database may be represented as a graph G(V, E). On executing a keyword query on the database, candidate nodes, that contain keywords in the query, are identified. Based on the identification, the candidate structures, such as trees and sub-graphs, covering such candidate nodes, are returned as the result. Certain commercially available database applications implement schema based techniques and graph based techniques for keyword based searching on databases.

In schema based techniques, a database schema is represented as a graph Gₛ (V, E), where V stands for a set of relations {R₁, R2, . . . , Rn} and E stands for primary key-key-foreign key connection. On the user entering a keyword query Q comprising of m keywords, {k1,k2, . . . , km}, the commercially available search engines find all tuples which include at least one keyword in the query Q and return a set of results. The minimal total joining network of tuples is provided to the user as the results.

In graph based techniques, the database itself is represented as a graph G_{d} (T, E), where T represents a set of tuples and E represents a primary key-foreign key connection. In some cases, a weight parameter is assigned to each edge E to reflect the distance between the corresponding tuples. On receiving a keyword query, the candidate structures, which may be in form of a reduced sub-tree and which contains all the keywords, are generated. Thereafter, techniques, such as a Steiner tree-based approach and a distinct root-based approach, may be used to rank the results in order of relevancy.

Both the schema based technique and graph based technique involve creating a large search space. Further these techniques, involving generation of sub-structures, are slow and consume considerable time on search processing.

Other commercially available techniques involve leveraging existing knowledge of the databases, such as logical views and query forms, to address the issues of structural ambiguity and query inefficiency. Another approach of keyword based searches involves identifying the tuples which contain the keywords and then combining the identified tuples to form view tuples by using primary key-foreign key connections. This approach reduces space maintenance overhead but increases processing load.

The systems and the methods, described herein, implement keyword based searching in databases. In one example, the method of keyword based searching is implemented using a keyword based search (KBS) system. The KBS system may be implemented by any computing system, such as personal computers, network servers and servers.

For initial setup, an inverted index is generated on the raw data stored in the database. In one example, a tuple is regarded as a document, wherein the body of the document contains all the values stored in the columns of the tuple. Further, each document is identified by a unique document ID. In one example, the concatenation of table ID of the tuple and the primary key value of the tuple may be regarded as the document ID. Thereafter, the inverted index is generated on all the tuples of all the relational tables. In one example, the inverted index contains a list of references to documents for each keyword. In another example, the inverted index may additionally include the position of each keyword within a document.

In said example, the query forms of an inbuilt application or an enterprise application running on the databases may be analyzed to extract query templates. The query templates are usually a parameterized multi-way join query on one or more tables. Usually, the “where” clause of the query templates include both static and dynamic predicates. The static predicates may be the join predicates and other form specific constraints, whereas the dynamic predicates are user provided inputs which are to be assigned to the parameters.

In one example, generating a join index corresponding to a query form may involve reformulating the query template corresponding to the query form by removing all the dynamic predicates from its query template. Further, the “select” clause of the query template may be replaced with a list of all the primary keys for the tables in the “from” clause. On execution, the reformulated query template shall result in the generation of all the primary key combinations for each join result, which may be recorded as the join index. The inverted index may then be used to map the document ID with the relevant join indices.

In operation, on receiving a keyword search query Q, a search may be conducted for detecting the presence of one or more of the keywords in the inverted index of the database to identify all relevant documents, i.e., the tuples. In one example, the tuples may be identified based on the presence of the keywords. Thereafter, a score function is computed between the query Q and each relevant document D. The score function may be based on a score factor. In one example, the score factor may be computed based on the number of keywords, present in the query, found in the each document D.

Thereafter, the document ID in the inverted index on the join indices may be searched to identify all relevant join result combinations. For each matching join result combination, the sum of the scores of all of its tuples may be computed. The join result combination may then be ranked based on a descending order of the sum. In one example, for every query form that has matches, the actual standard query language (SQL) query corresponding to the query form may be generated and executed on the database. The results of the execution may then be displayed to the user.

In one example, any updates made to the database may be detected based on database triggers. On detecting an update, the affected entries in the inverted index and the join indices using the document ID may be searched and updated. The incremental updates to the indices facilitate in efficiently capturing the underlying updates made to the databases.

Thus, the systems and the methods, described herein, facilitate keyword based searching in structured databases. The keyword based searching facilitates the users to search databases without having to learn about the database schema of the databases.

The above systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

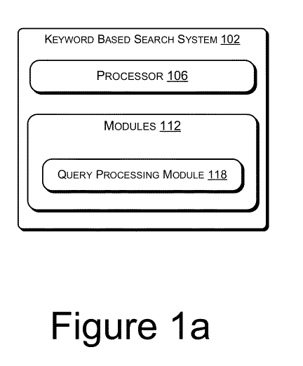

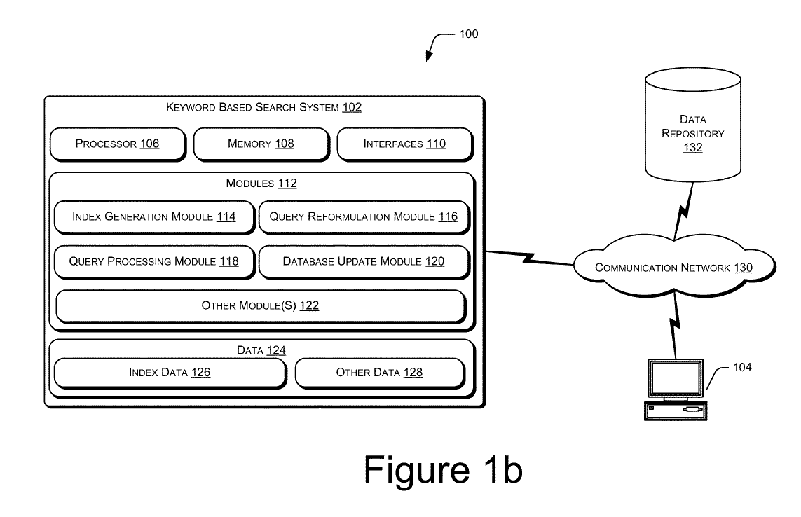

The manners in which the systems and methods for keyword based searching are implemented are explained in details with respect to FIGS. 1a, 1b, 2a, 2b, 2c and 3. While aspects of described systems and methods for keyword based searching can be implemented in any number of different computing systems, environments, and/or implementations, the examples and implementations are described in the context of the following system(s).

FIG. 1a schematically illustrates the components of a keyword based search (KBS) system 102, according to an example of the present subject matter. In one example, the KBS system 102 may be implemented as any commercially available computing system.

In one implementation, the KBS system 102 includes a processor 106 and modules 112 communicatively coupled to the processor 106. The modules 112, amongst other things, include routines, programs, objects, components, and data structures, which perform particular tasks or implement particular abstract data types. The modules 112 may also be implemented as, signal processor(s), state machine(s), logic circuitries, and/or any other device or component that manipulates signals based on operational instructions. Further, the modules 112 can be implemented by hardware, by computer-readable instructions executed by a processing unit, or by a combination thereof. In one implementation, the modules 112 include a query processing module 118.

In one example, the query processing module 118 receives a keyword based query, comprising at least one keyword, from a user. Thereafter, the query processing module 118 conducts a search on an inverted index associated with the database to detect the presence of at least one of the keywords in documents, identified by a document ID, present in the inverted index. Based on the searching, the query processing module 118 identifies the documents in which at least one of the keywords is present. The query processing module 118 further computes a score function for each of the identified documents and ranks the identified documents in a descending order of score function. The operation of the KBS system 102 is described in detail in conjunction with FIG. 1b.

FIG. 1b schematically illustrates a network environment 100 including the KBS system 102 according to another example of the present subject matter. The KBS system 102 may be implemented in various commercially available computing systems, such as personal computers, servers and network servers. The KBS system 102 may be communicatively coupled to various client devices 104, which may be implemented as personal computers, workstations, laptops, netbooks, smart-phones and so on.

In one implementation, the KBS system 102 includes a processor 106, and a memory 108 connected to the processor 106. Among other capabilities, the processor 106 may fetch and execute computer-readable instructions stored in the memory 108.

The memory 108 may be communicatively coupled to the processor 106. The memory 108 can include any commercially available non-transitory computer-readable medium including, for example, volatile memory, and/or non-volatile memory.

Further, the KBS system 102 includes various interfaces 110. The interfaces 110 may include a variety of commercially available interfaces, for example, interfaces for peripheral device(s), such as data input and output devices, referred to as I/O devices, storage devices, and network devices. The interfaces 110 facilitate the communication of the KBS system 102 with various communication and computing devices and various communication networks.

Further, the KBS system 102 may include the modules 112. In said implementation, the modules 112 include an index generation module 114, a query reformulation module 116, the query processing module 118, a database update module 120 and other module(s) 122. The other module(s) 122 may include programs or coded instructions that supplement applications or functions performed by the KBS system 102.

In an example, the KBS system 102 includes data 124. In said implementation, the data 124 may include an index data 126 and other data 128. The other data 128 may include data generated and saved by the modules 112 for providing various functionalities of the KBS system 102.

In one implementation, the KBS system 102 may be communicatively coupled to a data repository 132 over a communication network 130. The data repository 132 may be implemented as one or more computing systems which stores one or more databases. In one example, the data repository may be integrated with the KBS system 102.

The communication network 130 may include a Global System for Mobile Communication (GSM) network, a Universal Mobile Telecommunications System (UMTS) network, or any other communication network that use any of the commonly used protocols, for example, Hypertext Transfer Protocol (HTTP) and Transmission Control Protocol/Internet Protocol (TCP/IP).

For initial setup, the index generation module 114 retrieves raw data from the data repository 132 and generates an inverted index on the raw data. In one example, the inverted index may be implemented as an index data structure which stores a mapping from content, such as words and phrases, to its locations in a database or in a document or a set of documents. The index generation module 114 may regard a tuple as a document, wherein the body of the document contains all the values stored in the columns of the tuple. Further, the index generation module 114 may identify each document by assigning a unique document ID to each document. In one example, the index generation module 114 may concatenate a table ID of the tuple and the primary key value of the tuple to generate the document ID. The index generation module 114 generates an inverted index for all the tuples of all the relational tables in the databases stored in the data repository 132.

In said example, the query reformulation module 116 may analyze the query forms of an inbuilt application or an enterprise application running on the databases, stored in the data repository 132, to extract query templates. A sample query template may be SELECT column_name(s) FROM table_name1 INNER JOIN table_name2 ON table_name1.column_name=table_name2.column_name WHERE table_name1.col2=table_name2.col1. In the above template, column name(s) are the columns which the query would select from the tables named table_name1 and table_name2. The “where” clause mentions a condition for selection. Only those rows of the table named table name2 shall be selected whose columns match with the rows of the table named table_name1.

The query reformulation module 116 may further identify the static and dynamic predicates of the “where” clause. In one example, the query reformulation module 116 reformulates the query template by eliminating all the dynamic predicates from its query template. Further, the query reformulation module 116 replaces the “select” clause of the query template with a list of all the primary keys for the tables in the “from” clause. Thereafter, the query processing module 118 executes the reformulated query to generate all possible primary key combinations for each join result. The primary key combinations may be saved by the query processing module 118 as the join index in the index data 126. The index generation module 114 may then map the document ID with the relevant join indices using the inverted index.

In operation, the user may perform a keyword based search using an interface provided by the KBS system 102. The query processing module 118 may receive the keyword search query Q from the user's client device 104. The query processing module 118 may then conduct a search for detecting the presence of all the keywords in the inverted index of the databases, stored in the data repository 132, to identify all relevant documents, i.e. the tuples.

The query processing module 118 may then compute a score function between the query Q and each relevant document D. An example of a score function is provided as equation 1 (Eq. 1) below.

$$Score ( Q , D ) = coord ( Q , D ) {\sum }_{t in Q} ( tf ( t in Q ) * {idf ( t )}^{2} * t . boost * norm ( t , D ) ) \qquad Eq . ( 1 )$$

In the aforementioned equation 1, coord(Q,D) represents a score factor which is computed by the query processing module 118 based on the number of keywords present in specified document D. The term tf-idf (term frequency-inverse document frequency) is a numerical statistic which signifies the importance of a keyword in a document in a collection of documents. The tf-idf value increases proportionally to the number of times a keyword appears in the document, but is offset by the frequency of the word in the collection of documents. The offset helps to control that, in general, some words are generally more common than others.

Further, t.boost is a weight parameter which reflects the importance of the keyword in the document D, and norm(t, D) is indicative of the importance of document D during the generation of the inverted index.

The query processing module 118, thereafter, searches for the document ID in the inverted index of the join indices to identify all relevant join result combinations. For each matching join result combination, the query processing module 118 may compute the sum of the scores of all of its tuples. The query processing module 118 may then rank the join result combination in a descending order of the sum.

In one example, for every query form that has matches, the query processing module 118 may generate and execute the actual SQL query corresponding to the query form on the database stored in the data repository 132. The results of the execution may then be displayed to the user.

In one example, the database update module 120 may detect any updates made to the databases stored in the data repository 132 based on database triggers. On detecting an update, the database update module 120 may search and update the affected entries in the inverted index and the join indices using the document ID.

Thus, the KBS system 102 facilitates keyword based searching in structured databases. The keyword based searching facilitates the users to search databases without having to learn about the database schema of the databases.

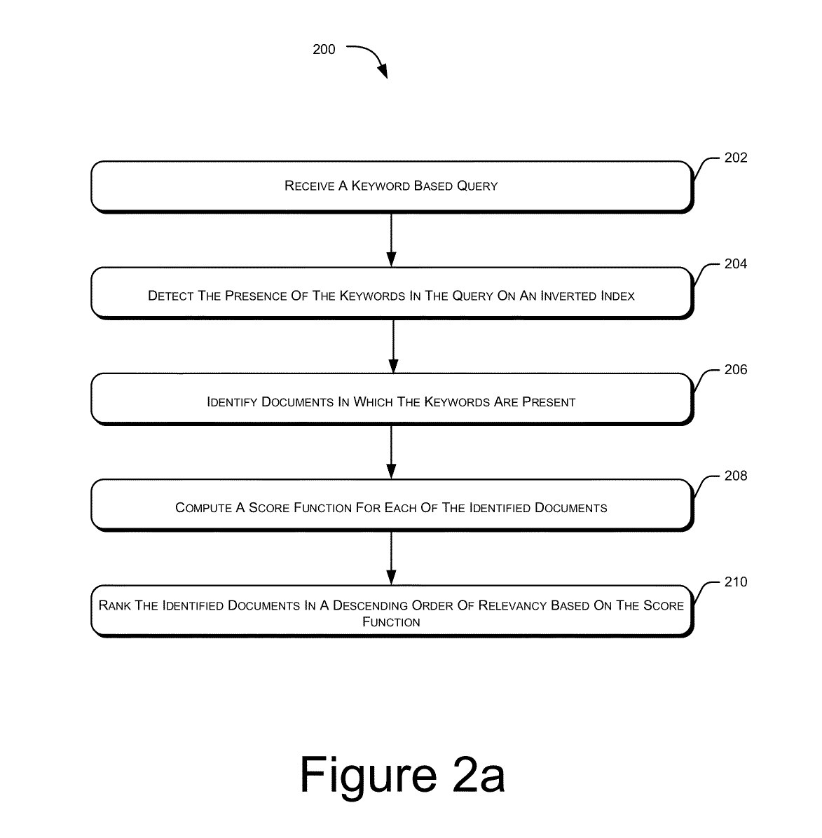

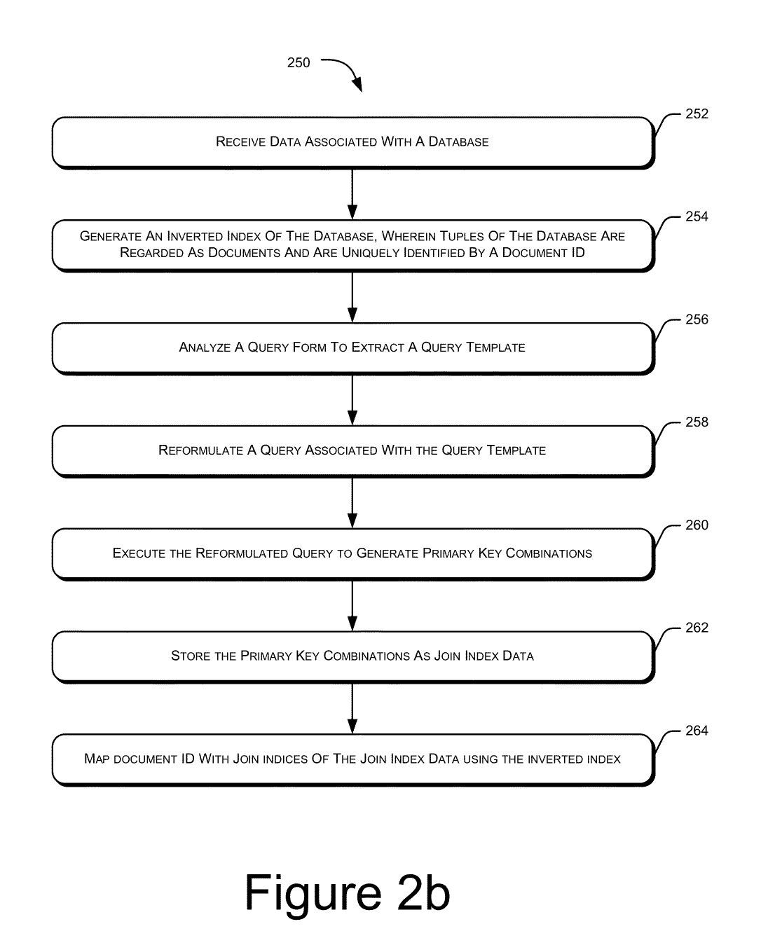

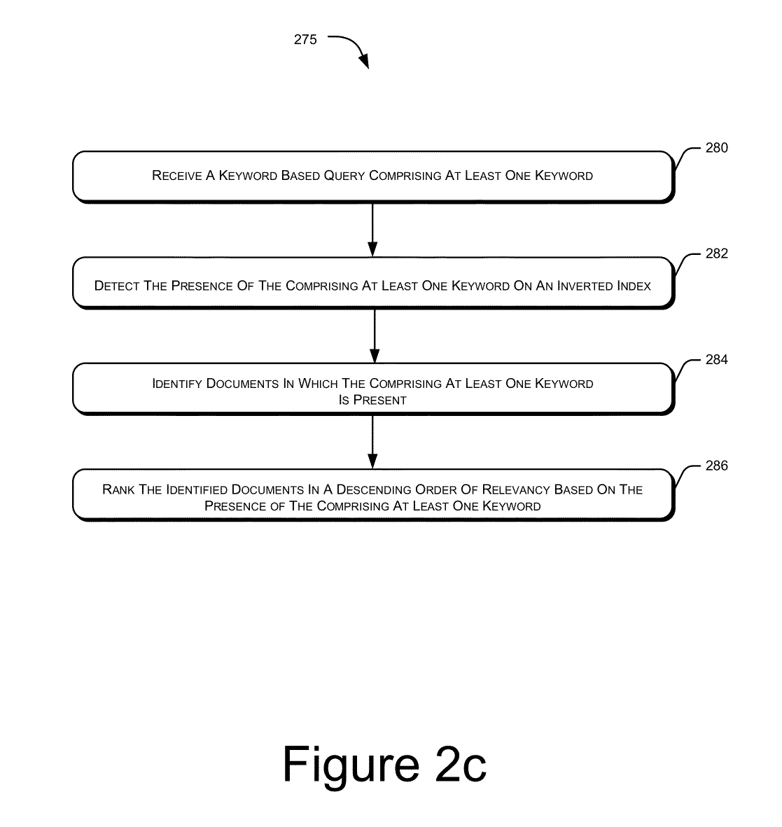

FIGS. 2a, 2b and 2c illustrate methods 200, 250 and 275 for keyword based searching, according to an example of the present subject matter. The order in which the methods 200, 250 and 275 are described is not intended to be construed as a limitation, and any number of the described method blocks can be combined in any order to implement the methods 200, 250 and 275, or an alternative method. Additionally, individual blocks may be deleted from the methods 200, 250 and 275 without departing from the spirit and scope of the subject matter described herein. Furthermore, the methods 200, 250 and 275 may be implemented in any suitable hardware, computer-readable instructions, or combination thereof.

The steps of the methods 200, 250 and 275 may be performed by either a computing device under the instruction of machine executable instructions stored on a storage media or bydedicated hardware circuits, microcontrollers, or logic circuits. Herein, some examples are also intended to cover program storage devices, for example, digital data storage media, which are machine or computer readable and encode machine-executable or computer-executable programs of instructions, where said instructions perform some or all of the steps of the described methods 200, 250 and 275. The program storage devices may be, for example, digital memories, magnetic storage media, such as a magnetic disks and magnetic tapes, hard drives, or optically readable digital data storage media.

With reference to method 200 as depicted in FIG. 2a, as depicted in block 202, a keyword based query is received from the user. In one example, the query processing module 118 receives the keyword based query from the user's client devices 104.

As shown in block 204, the presence of the keywords in the query on an inverted index is detected. In one example, the query processing module 118 conducts a search on the inverted index to determine the presence of the keywords on the inverted index.

As illustrated in block 206, the documents in which the keywords are present are identified. In one example, the query processing module 118 identifies the documents in which the keywords are present based on the search conducted at block 204.

At bock 208, a score function for each of the identified documents is computed. In one example, the query processing module 118 computes the score function for each of the identified documents based on equation 1 provided earlier in this document.

As depicted in block 210, the identified documents are ranked in a descending order of relevancy based on the score function. In one example, the query processing module 118 ranks the identified documents in a descending order of the value of the score function.

With reference to method 250 as depicted in FIG. 2b, data associated with a database is received at block 252. In one example, the index generation module 114 retrieves the data associated with a database.

As illustrated in block 254, an inverted index of the database is generated. In the inverted index, the tuples of the database are regarded as documents and are uniquely identified by a document id. In one example, the index generation module 114 generates the inverted index.

As shown in block 256, a query form is analyzed to extract a query template. In one example, the query reformulation module 116 may analyze the query forms of an inbuilt application or an enterprise application running on the database to extract query templates

At block 258, a query, associated with the query template, is reformulated. In one example, the query reformulation module 116 reformulates the query, associated with the query template. In said example, the query reformulation module 116 may eliminate the dynamic predicates from the query template. Further, the query reformulation module 116 may replace the “select” clause of the query template with a list of all the primary keys for the tables in the “from” clause.

As depicted in block 260, the reformulated query is executed to generate primary key combinations. In one example, the query processing module 118 executes the reformulated query to generate all possible primary key combinations for each join result.

As shown in block 262, the primary key combinations are stored as join index data. In one example, the query processing module 118 saves the primary key combinations as the join index in the index data 126.

As illustrated in block 264, the document ID is mapped with join indices of the join index data using the inverted index. In one example, the index generation module 114 may map the document ID with the relevant join indices using the inverted index.

With reference to method 275 as depicted in FIG. 2c, a keyword based query, comprising at least one keyword, is received from the user at block 280. In one example, the query processing module 118 receives the keyword based query from the user's client devices 104.

As shown in block 282, the presence of the at least one keyword on an inverted index is detected. In one example, the query processing module 118 conducts a search on the inverted index to determine the presence of the at least one keyword on the inverted index.

As illustrated in block 284, the documents, in which the at least one keyword is present, are identified. In one example, the query processing module 118 identifies the documents, in which the at least one keyword is present, based on the search conducted at block 282.

As depicted in block 286, the identified documents are ranked in a descending order of relevancy based on the presence of the at least one keyword. In one example, the query processing module 118 ranks the identified documents in a descending order of relevancy.

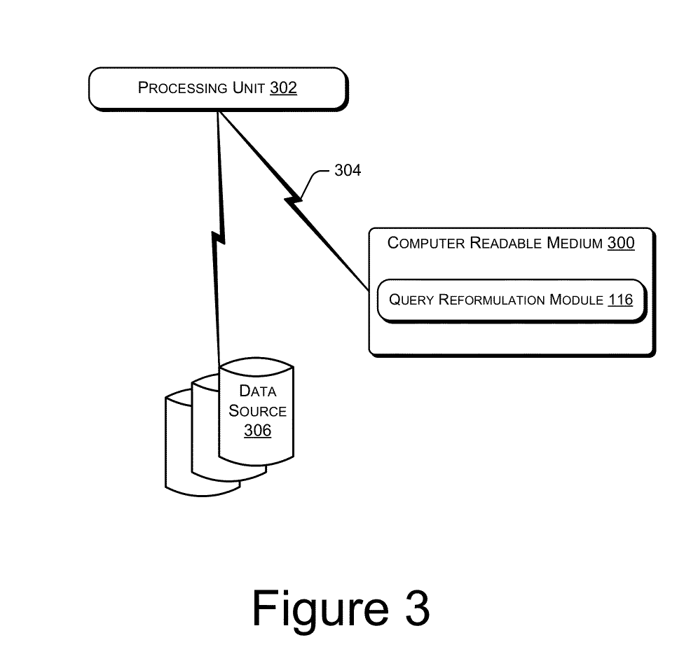

FIG. 3 illustrates a computer readable medium 300 storing instructions for keyword based searching, according to an example of the present subject matter. In one example, the computer readable medium 300 is communicatively coupled to a processing unit 302 over communication link 304.

For example, the processing unit 302 can be a computing device, such as a server, a laptop, a desktop, a mobile device, and the like. The computer readable medium 300 can be, for example, an internal memory device or an external memory device or any commercially available non transitory computer readable medium. In one implementation, the communication link 304 may be a direct communication link, such as any memory read/write interface. In another implementation, the communication link 304 may be an indirect communication link, such as a network interface. In such a case, the processing unit 302 can access the computer readable medium 300 through a network.

The processing unit 302 and the computer readable medium 300 may also be communicatively coupled to data sources 306 over the network. The data sources 306 can include, for example, databases and computing devices. The data sources 306 may be used by the requesters and the agents to communicate with the processing unit 302.

In one implementation, the computer readable medium 300 includes a set of computer readable instructions, such as the index generation module 114, the query reformulation module 116, and the query processing module 118. The set of computer readable instructions can be accessed by the processing unit 302 through the communication link 304 and subsequently executed to perform acts for keyword based searching.

On execution by the processing unit 302, the query reformulation module 116 analyzes a query form, associated with a database, to extract a query template. The query reformulation module 116 extracts a query associated with the query template and reformulates the query to generate primary key combinations for each join result for the query form. The query reformulation module 116, thereafter, stores the primary key combinations as join indices and maps the document ID with the join indices based on the inverted index.

Although implementations for keyword based searching have been described in language specific to structural features and/or methods, it is to be understood that the appended claims are not necessarily limited to the specific features or methods described. Rather, the specific features and methods are disclosed as examples of systems and methods for keyword based searching.

I/We claim:

1. A keyword based search (KBS) system (102), for keyword based searching in a database, comprising:
a processor (106); and
a query processing module (118), coupled to the processor (106), to:
receive a keyword based query, comprising at least one keyword, from a user;
search an inverted index associated with the database to detect the presence of at least one of the keywords in documents, identified by a document ID, present in the inverted index;
identify, based on the searching, the documents in which at least one of the keywords is present;
compute a score function for each of the identified documents based on the presence of the keywords; and
rank the identified documents in a descending order of the score function.

2. The KBS system (102) as claimed in claim 1 further comprising an index generation module (114), coupled to the processor (106), to generate the inverted index of the database.

3. The KBS system (102) as claimed in claim 1 further comprising a query reformulation module (116), coupled to the processor (106) to:
analyze a query form, associated with the database for querying the database, to extract a query template;
generate a query associated with the query template;
reformulate the query to generate primary key combinations for each join result for the query form; and
store the primary key combinations as join indices.

4. The KBS system (102) as claimed as claimed in claim 3, further comprising an index generation module (114), coupled to the processor (106), to map the document ID with the join indices based on the inverted index.

5. The KBS system (102) as claimed as claimed in claim 1, further comprising a database updatate module (120), coupled to the processor (106), to:
detect an update made to the database based on database triggers;
identify affected entries in the inverted index; and
update the inverted index based on the identification.

6. A method for keyword based searching in a database, comprising:
receiving a keyword based query, comprising at least one keyword, from a user;
searching an inverted index associated with the database to detect the presence of at least one of the keywords in documents, identified by a document ID, present in the inverted index;
identifying, based on the searching, the documents as relevant documents in which at least one of the keywords is present; and
ranking the identified documents in a descending order of relevancy.

7. The method as claimed in claim 6, wherein the ranking further comprises:
computing a score function for each of the identified documents; and
ordering the identified documents in a descending order of score function.

8. The method as claimed in claim 6, the method further comprising:
analyzing a query form, associated with the database, to extract a query template;
extracting a query associated with the query template;
reformulating the query to generate primary key combinations for each join result for the query form;
storing the primary key combinations as join indices; and
mapping the document ID with the join indices based on the inverted index.

9. The method as claimed in claim 8, wherein the reformulating further comprises:
eliminating dynamic predicates from the query template; and
replacing a “select” clause of the query template with a list of all the primary keys for the tables, of the database, in the “from” clause of the query template.

10. The method as claimed in claim 6, the method further comprising generating the inverted index of the database.

11. The method as claimed in claim 6, the method further comprising:
detecting an update made to the database based on database triggers;
identifying affected entries in the inverted index; and
updating the inverted index based on the identifying.

12. A non-transitory computer-readable medium having a set of computer readable instructions that, when executed, cause a keyword based search (KBS) system (102) to:
analyze a query form, associated with a database, to extract a query template;
extract a query associated with the query template;
reformulate the query to generate primary key combinations for each join result for the query form;
store the primary key combinations as join indices; and
map the document ID with the join indices based on the inverted index.

13. The non-transitory computer-readable medium as claimed in claim 12, wherein the instructions executed further cause the KBS system (102) to:
receive a keyword based query, comprising at least one keyword, from a user;
search an inverted index associated with the database to detect the presence of at least one of the keywords in documents, identified by a document ID, present in the inverted index;
identify, based on the searching, the documents in which at least one of the keywords is present;
compute a score function for each of the identified documents; and
rank the identified documents in a descending order of score function.
